(19) United States
(12) Patent Application Publication
(10) Pub. No.: US 2005/0180695 A1
(43) Pub. Date: Aug. 18, 2005

(54) Method and apparatus for planar lightwave circuits pigtailing

(75) Inventors: Rafael Bronstein, Kevar Sava (IL); Serge Steinblatt, Raanana (IL); Daniel Leigh, Jerusalem (IL)

Correspondence Address: DR. MARK FRIEDMAN LTD.;C/o Bill Polkinghorn, Discovery Dispatch, 9003 Florin Way, Upper Malboro, MD, 20772, US

(73) Assignee: SAGITTA ENGINEERING SOLUTIONS LTD.

(21) Appl. No.: 10/683,292

(22) Filed: Oct. 14, 2003

Related U.S. Application Data
(60) Provisional application No. 60/418,322, filed on Oct. 15, 2002.

(51) Int. Cl. G02B 6/30

(52) U.S. Cl. 385/49

(57) ABSTRACT

A method of bonding of an optical fiber to at least one port of a Planar Lightwave Circuit (PLC). The method includes steps of depositing an index matching and bonding material on the tip of the optical fiber, bringing in contact with the planar lightwave circuit (PLC) the tip of optical fiber having index matching and bonding material on it in a way where the index matching and bonding material serves as an interface between the port of the planar lightwave component (PLC) and the tip of optical fiber, and bonding the tip of optical fiber to the planar lightwave component by curing the index matching and bonding material in the interface between the planar lightwave component and optical fiber tip by curing radiation. The method is characterized in that the curing radiation from a source of curing radiation is delivered along the optical fiber to the tip of the optical fiber to be bonded.

### FIELD OF THE INVENTION

The present invention relates to the field of fiber optics, and planar lightwave circuits and, more particularly to methods of optical fibers connection or pigtailing to planar lightwave circuits.

### BACKGROUND OF THE INVENTION

With the advance of optical communications, the industry is gradually moving from discrete elements to larger scale packaging of different photonic devices. A sample of such large scale packaging devices are all classes of Planar Lightwave Circuits (PLC). Typical representatives of PLCs are Arrayed Waveguide Gratings (AWG), Variable Optical Attenuators (VOA) T-Tree and Star couplers, wave length selective coupler and others.

Planar Lightwave Circuits integrate multiple functions in one package. They are typically manufactured on silicon wafers, using semiconductor manufacturing technologies and systems with each wafer containing a large number of PLCs. Once the wafer is diced into individual PLCs each of them is packaged as a whole, eliminating some of the packaging required for discrete elements and reducing overall packaging size. Silicon does possess all of the properties required by photonic applications and some of the PLCs are manufactured of Lithium Niobate and even of glass.

Although the PLCs have many advantages over discrete components, the coupling of light into and out of the waveguide is problematic. The cross section of a waveguide is typically rectangular, as compared to circular for optical fibers, with only few micron long sides and light coming in on a fiber, that has larger dimensions and circular cross section has to be very accurately aligned, typically fractions of microns, to properly enter the waveguide in the planar device.

PLCs usually have a large number of input and output ports and typically, an optical fiber connects each of the ports to the rest of the components of the network. There are a number of known technologies for coupling or bonding a silica glass optical fiber to the silicon body of the PLC. Epoxy adhesive or simply epoxy is the predominant current bonding technology. The epoxy is introduced between the fiber and appropriate PLC port and cured with the help of UV radiation. Epoxy serves not only as a bonding material; it enables some refractive index matching reducing transmission losses. Although simple, the method suffers of a number of shortcomings: Silicon does not transmit UV radiation and curing of the epoxy is not uniform; Epoxy curing time is relatively long and the fiber frequently chances its position after alignment; Epoxy out gassing adversely affects the hermetic photonic element packaging, and the transmission of the epoxy changes with the time.

U.S. Pat. No. 6,296,401 to Paris and U.S. Pat. No. 6,411,759 to Beguin et al., disclose methods of optical fiber to PLC connection by fusion. Paris teaches a method for fusion pigtailing an optical fiber to an integrated optical device (PLC) with an optical device formed on a substrate. The substrate includes a groove under and behind an interface between the optical fiber and the optical device. Provision of such a groove allows the substrate to be used for alignment and support of the optical fiber, while reducing fusion loss and improving durability of the interface. Paris does not disclose the method according to which fiber fusion is performed.

Beguin teaches a fusion joint between a waveguide (PLC) and an optical fiber created by irradiating the interface between the optical fiber and the waveguide using a laser beam. The spatial distribution of the energy furnished to the interface presents a central zone of which the energy is reduced with respect to a peripheral zone, whereby to enable a relatively high energy laser to be used while avoiding bending of the waveguide. The laser beam is caused to irradiate a higher energy density upon the waveguide than the optical fiber, typically by offsetting the center of the laser beam towards the waveguide. The fusion is performed while a force F urges the waveguide and optical fiber towards one another, to avoid the creation of a void at the boundary.

Beguin irradiates a relatively large area that includes both the waveguide and the fiber. This causes some waste of laser energy, the heating process is not a homogenous one, the fusion process take excessive time and because of the PLC heating requires additional annealing steps.

U.S. Pat. No. 6,360,039 to Bernard et al., discloses a method of joining at least two optical components. One of the optical components having a surface that has a comparatively larger cross-sectional area than the surface of the other optical component e.g. an optical fiber. The optical components are joined together by fusion-splicing, using a laser. The laser radiation is organized in an annular pattern around the fiber and makes the heating of the other optical component and the fiber tip more homogenous. The fusion is achieved by melting a small area surrounding the joint with the fiber section on the larger than the optical fiber glass component.

Parenthetically the terms “joint” and “bond” used throughout the text of the present application have the same meaning. To avoid confusion bond will be used predominantly for the cases where an interface created by an adhesive type of material exists between the fiber and the PLC. The terms “laser radiation” and “laser energy” used throughout the text of the present application have the same meaning.

This technique could not however be applied for joining fiber to optical components having an equal-with-the-fiber diameter and to Planar Lightwave Circuit (PLC) fusion, since it would cause excessive heating of the area of the PLC adjacent to the particular waveguide. Further to this, the annular form of the laser irradiating beam seams to be very difficult if not impossible to create in the limited space the optical fiber with the PLC joint.

There is therefore a need in the industry to provide a method of reliable pigtailing of the PLCs with optical fibers.

There is a further need in the industry to provide a method of fast and reliable optical fiber to a PLC or another planar glass component bonding where the refractive index matching and bonding material would not be out gassing later and would not adversely affect the hermetic photonic element packaging.

There is an additional need in the industry to provide a method of optical fiber to a PLC or another planar glass component fusion/joining method free of above-mentioned drawbacks. The method of fiber joining and fiber fusion that would lend itself to automation enabling a large amount of pigtails to be produced in a relatively short time.

There is also a need in a method of optical fiber to a PLC joining or fusion that will have low insertion losses, support high-density components placement and provide smooth assembly technologies without adversely affecting the light transmission properties of the joint.

### SUMMARY OF THE INVENTION

An object of the present invention is to provide a method of reliable pigtailing of the PLCs with optical fibers without adversely affecting the light transmission properties of the joint.

An additional objective of the present invention is to provide a method of fast and reliable optical fiber to a PLC or another planar glass component joining and bonding that lends itself to automation enabling production of large amount of joints and bonds in a relatively short time.

Still an additional objective of the present invention is to provide a method of fast and reliable bonding of an optical fiber to a PLC or another planar glass component, where the refractive index matching and bonding material would not be outgassing later and would not adversely affect the hermetic photonic element packaging.

Another objective of the present invention is to provide a high-yield, automated method, of optical fiber to a PLC or another planar glass made component fusion joining.

A further objective of the present invention is to provide a method of optical fiber to a PLC attachment that will have low insertion losses, support high density components placement and provide smooth assembly and joining technologies without adversely affecting the light transmission properties of the joint.

According to one of the exemplary embodiments of the present invention, these objectives may be achieved by a method of bonding of an optical fiber to at least one port of a Planar Lightwave Circuits (PLC), comprising steps of:
a. depositing an index matching and bonding material on the tip of said optical fiber;
b. bringing in contact with said planar lightwave component (PLC) said tip of optical fiber having index matching and bonding material on it in a way where said index matching and bonding material serves as an interface between said port of the planar lightwave component (PLC) and said tip of optical fiber;
c. bonding said tip of optical fiber to said planar lightwave component by curing said index matching and bonding material in said interface between the planar lightwave component and optical fiber tip by curing radiation;
d. characterized in that said curing radiation from a source of curing radiation is delivered along said optical fiber to said tip of the optical fiber to be bonded;

In one of the embodiments the index matching and bonding material, which is an IR curable material bonds an optical fiber to a port of a Planar Lightwave Circuits. The index matching and bonding material may optionally be a glass powder paste or a sol-gel material and preferably IR curable glass powder paste or sol-gel material sensitized to absorb particular wavelength of laser radiation. Laser radiation may be supplied to the curing section in a continuous mode or optionally and preferably in a pulse mode. The optical fiber bonded to at least one port of a Planar Lightwave Circuits may optionally be supplied from a reel.

When said optical fiber is supplied from a real, following the bonding it may be cleaved (cut) to a desired length. A laser that enables both fiber stripping and fiber cleaving processes preferably performs fiber cleaving. Alternatively, precut optical fiber pigtails supplied from a storage magazine can be used in the bonding process.

The sol-gel material is preferably a non-organic sol-gel material. Curing converts the glass powder paste or the sol-gel material into transparent ceramics that does not outgas after it has been packaged with the bonded components.

In another embodiment the index matching and bonding material may optionally be epoxy adhesive and preferably IR curable epoxy adhesive sensitized to absorb particular wavelength of laser radiation. Laser radiation may be supplied to the curing section in a continuous mode or optionally and preferably in a pulse mode. The optical fiber bonded to at least one port of a Planar Lightwave Circuits may optionally be supplied from a reel.

The source of curing radiation is a laser. It may be optionally a laser diode or a solid-state laser and it is preferably optically coupled to the distal end of the optical fiber reel. The bonded fiber is cut to a desired length and the reel releases an additional piece of the fiber.

According to an additional exemplary embodiment the objectives of the present invention may be achieved by a method of joining by laser fusion of an optical fiber to at least one port of a Planar Lightwave Circuits (PLC), comprising steps of:
a. depositing a laser radiation absorption enhancing material on the tip of said optical fiber;
b. bringing in contact with said planar lightwave component (PLC) said tip of optical fiber having laser absorption enhancing material on it;
c. characterized in that said laser heating and melting energy from a source of laser heating and melting energy is delivered along said optical fiber to said tip of the optical fiber;
d. such that said tip of optical fiber becomes fused to said planar lightwave component by said laser heating and melting radiation;

The laser absorption enhancing material is optionally a laser radiation absorbing dye. The dye preferably absorbs laser radiation at a wavelength different from the PLC and the optical fiber operational wavelength. The dye is preferably an organic dye that burns out during the fusion process without leaving traces and affecting bond transmission characteristics.

The optical fiber joined/fused to at least one port of a Planar Lightwave Circuits may optionally be supplied from a reel. When said optical fiber is supplied from a real, following the joining it may be cleaved (cut) to a desired length. A laser that enables both fiber stripping and fiber cleaving processes preferably performs fiber cleaving. Alternatively, precut optical fiber pigtails supplied from a storage magazine can be used in the joining process.

The source of fiber tip heating, and melting radiation is preferably a laser radiation source. It may be optionally a laser diode or a solid state laser and it is preferably optically coupled to the distal end of the optical fiber reel. Provided by the laser source heating and melting radiation is optionally and preferably supplied as pulses of laser radiation. The repetition rate of the pulses of laser energy is such that most of the energy is absorbed by fiber tip. The tip melts before heat conductive mechanism conducts the heat to remote parts of the optical fiber or the PLC. The fused fiber is cut to a desired length and the reel releases an additional piece of the fiber.

According to further exemplary embodiment the objectives of the present invention may be achieved by a method of joining by laser fusion of an optical fiber to at least one port of a Planar Lightwave Circuits (PLC), comprising steps of:
a. bringing in contact (a micron gap may exist) with said port and its surrounding it area (facet) of said planar lightwave component (PLC) the tip of said optical fiber;
b. characterized in that laser heating and melting energy from a source of laser heating and melting energy is delivered along said optical fiber to said tip of the optical fiber;
c. such that said tip of optical fiber becomes fused to said planar lightwave component by said laser heating and melting energy;

No laser absorption enhancing materials participate in the process. The reflected part from the planar component facet laser heating and melting energy sums-up with conducted along the optical fiber laser heating and melting energy and the sum of these two energies causes said melting and fusing of said tip of the optical fiber.

Optionally fiber to Planar Lightwave Circuits bonding may take place by melting of a micron thin layer of a PLC facet. This typically occurs when the melting temperature of the material of which the Planar Lightwave Circuits is made, for example silicon is significantly lower than the melting temperature of the silica glass material of which the optical fiber is made.

The laser heating and melting radiation is supplied through the fiber to be joined. The cross section of multimode fibers is sufficient to conduct large energy densities required for the fusion and joining process. When use of single mode fiber is required optionally and preferably double clad single mode fibers can be used for the fusion and bonding process. The laser heating and melting radiation is supplied through the inner clad of the double clad fiber to be bonded.

The optical fiber fused to at least one port of a Planar Lightwave Circuits may optionally be supplied from a reel. When said optical fiber is supplied from a real, following the joining (fusing) it may be cleaved (cut) to a desired length. A laser that enables both fiber stripping and fiber cleaving processes preferably performs fiber cleaving. Alternatively, precut optical fiber pigtails supplied from a storage magazine can be used in the joining process.

The source of fiber tip heating, and melting energy (radiation) is preferably a laser radiation source. It may be optionally a laser diode or a solid-state laser and it is preferably optically coupled to the distal end of the optical fiber reel. Provided by the laser source heating and melting radiation is optionally and preferably supplied as pulses of laser radiation. The repetition rate of the pulses of laser heating and melting radiation is such that most of the energy is absorbed by fiber tip and only a minimal micron length of the fiber is heat. Fused fiber is cut to a desired length and the reel releases an additional piece of the fiber.

According to yet a further exemplary embodiment the objectives of the present invention may be may be achieved by a method of joining by laser fusion of an optical fiber to at least one port of a Planar Lightwave Circuits (PLC), comprising steps of:
a. heating the tip of said optical fiber to a temperature (approximately 1100° C.) where fiber absorption of the laser heating and melting radiation becomes non-linear;
b. bringing in contact with said planar lightwave component (PLC) said heated tip of optical fiber;
c. characterized in that said laser heating and melting energy from a source of laser heating and melting energy is delivered along said optical fiber to said tip of the optical fiber;
d. such that said tip of optical fiber becomes fused to said planar lightwave component by said laser heating and melting radiation;

A filament or an arc may optionally heat the fiber tip. The optical fiber joined to at least one poll of a Planar Lightwave Circuits may optionally be supplied from a reel. The source of fiber tip heating, and melting radiation is optionally a laser radiation source. It may optionally be a laser diode or a solid-state laser and it is preferably optically coupled to the optical fiber reel. Provided by the laser diode heating and melting radiation is optionally and preferably supplied as pulses of laser radiation. The repetition rate of the pulses of laser energy is such that most of the energy is absorbed by fiber tip before heat conductive mechanism conducts the heat to remote parts of the optical fiber or the PLC. Fused fiber is cut to a desired length and the reel releases an additional piece of the fiber. A laser that enables both fiber stripping and fiber cleaving processes preferably performs fiber cleaving. Alternatively, precut optical fiber pigtail supplied from a storage magazine can be used in the joining process.

The method as described above provides advantages over the prior art in that the curing of the index matching and bonding material is performed by curing radiation simultaneously through the complete joint cross section and does not create stress in the joint. The bonding material is glass having a refractive index close to the refractive index of the fiber. Because of curing the glass powder or sol-gel material becomes ceramics and does not out gas at a later period. In case of a bond created by fiber fusion the bonding material is the same material of which the planar component or fiber are made and only one optical interface between the fused optical fiber and the PLC is created.

An additional advantage of the invention is that the curing or fusing radiation is delivered through the fiber itself and does not require additional optical systems for delivering UV Curing radiation. This leads to a lower cost machine and simple process automation means.

A further advantage of the method of the present invention is that the laser curing or heating and melting energy is supplied in pulses and heats a minimal (micron) length of the optical fiber or of the PLC.

Therefore, the present invention also provides a method of connecting an optical fiber having a free tip (end-face) to a PLC port having a free end-face without adversely affecting the path of light exiting or entering the optical fiber or the PLC.

### BRIEF DESCRIPTION OF DRAWINGS

The invention is herein described, by way of non-limiting examples only, with reference to the accompanying drawings, wherein:

FIGS. 1A, 1B, and 1C are illustrations of some Prior Art fiber bonding and fiber laser fusion methods;

FIG. 2 is an illustration of an optical fiber to PLC bonding method performed in accordance with one exemplary embodiment of the present invention;

FIG. 3 is a flowchart illustrating steps of an optical fiber to PLC bonding method performed in accordance with the exemplary embodiment of FIG. 2 of the present invention;

FIG. 4 is an illustration of an optical fiber to PLC laser fusion method performed in accordance with another exemplary embodiment of the present invention;

FIG. 5 is a flowchart illustrating steps of an optical fiber to PLC laser fusion method performed in accordance with the exemplary embodiment of FIG. 4 of the present invention;

FIG. 6 is an illustration of an optical fiber to PLC laser fusion method performed in accordance with a another exemplary embodiment of the present invention, and

FIG. 7 is an illustration of an optical fiber to PLC laser fusion method performed in accordance with a further exemplary embodiment of the present invention;

### DESCRIPTION OF THE EXEMPLARY EMBODIMENTS

The principles and execution of a method according to the present invention, and the operation and properties of an apparatus useful in implementing the present invention may be understood with reference to the drawings and the accompanying description of non-limiting, exemplary embodiments. The drawings referred to in this description should be understood as not being drawn to scale.

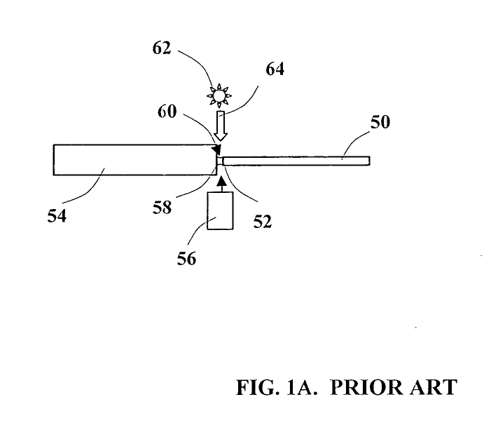

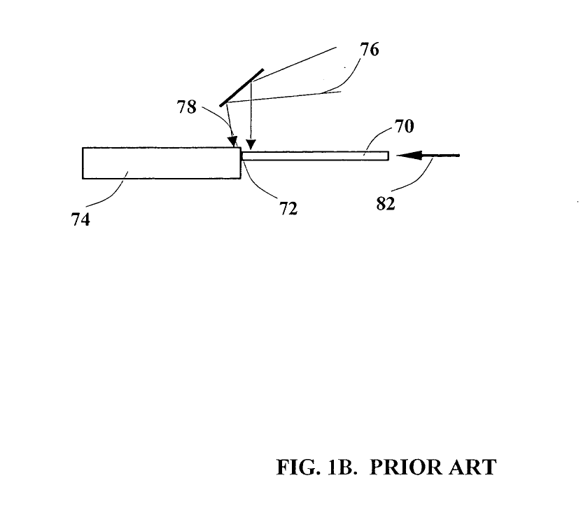

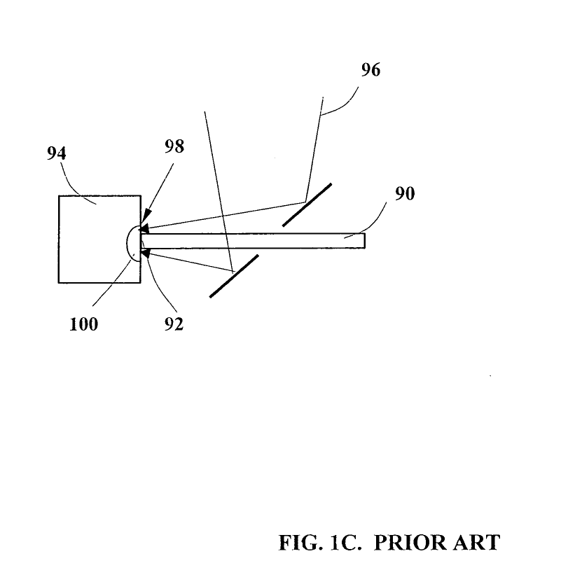

FIGS. 1A, 1B, and 1C are illustrations of some Prior Art fiber bonding and fiber laser fusion methods. FIG. 1A shows a conventional optical fiber epoxy bonding process. Numeral 50 indicates an optical fiber having a tip 52. Tip 52 of optical fiber 50 is in contact with an input/output port of PLC 54 to which it has to be bonded. (Actually a micron size gap may exist between the tip of the fiber and the input/output port of the PLC.) A dispenser 56 injects epoxy 58 into gap 60 formed between PLC 54 and fiber tip 52. A source of UV light 62 provides epoxy-curing radiation 64. Epoxy curing radiation 64 typically, irradiates the joint from one side only. Fiber 50 is previously cut to a desired length.

FIG. 1B shows a Prior Art optical fiber to PLC fusion process. Numeral 70 indicates an optical fiber having a tip 72. Tip 72 of optical fiber 70 is in contact with an input/output port of PLC 74 to which it has to be fused. A laser beam 76 irradiates both fiber tip 72 and surrounding it section 78 of PLC 74. Force 82 urges optical fiber 70 against PLC 74. Laser beam 76 melts fiber tip 72 and fuses fiber 70 to PLC 74. Laser beam 76 typically, irradiates the joint from one side only. Fiber 70 is previously cut to a desired length.

FIG. 1C shows a Prior Art optical fiber to another glass photonic component having a larger than optical fiber size fusion process. Numeral 90 indicates an optical fiber having a tip 92. Tip 92 of optical fiber 90 is in contact with a glass photonic component 94 to which it has to be fused. A laser beam 96 irradiates an annular section 98 of glass photonic component 94. Laser beam 96 melts a section 100 of glass photonic component 94. Optical fiber 90 is fused to melted section 100 of glass photonic component 94. Fiber 90 is previously cut to a desired length.

In all of the described Prior Art cases alignment facilities (not shown), prior to bonding or laser fusion, place the optical fiber in a desired position with respect to the input/output port of the PLC.

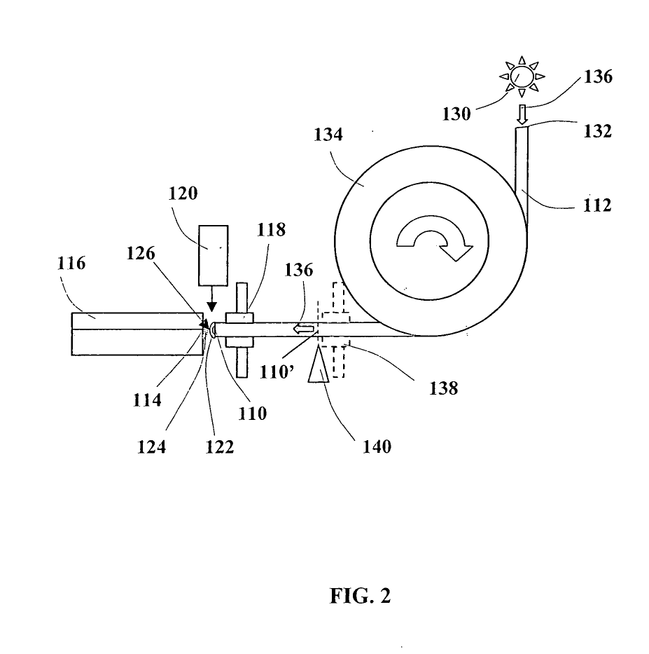

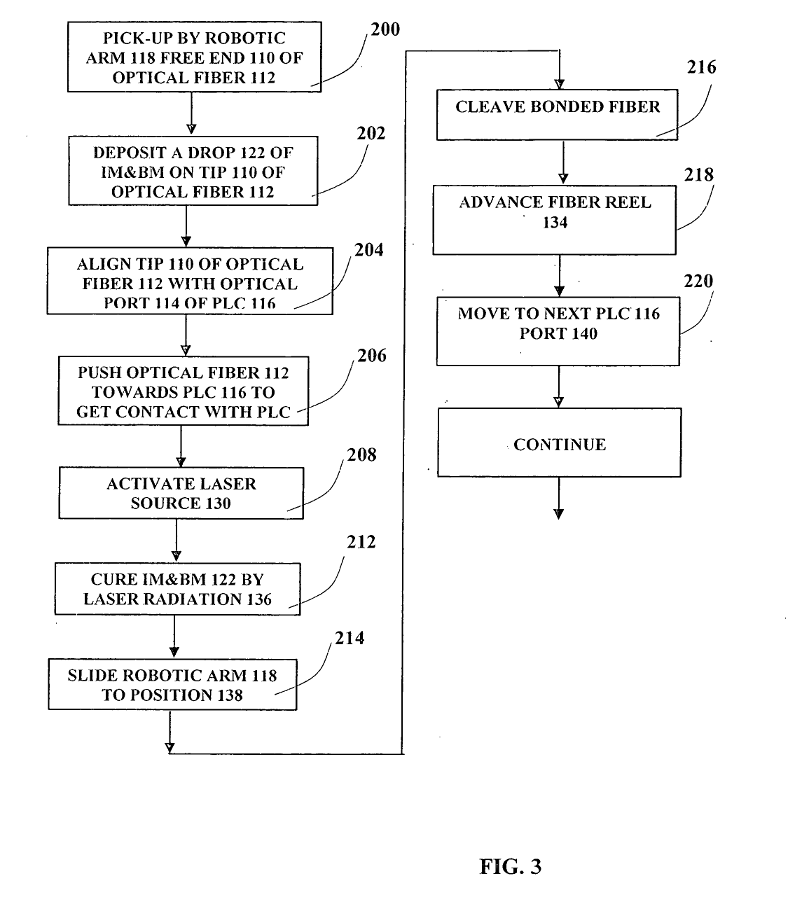

FIG. 2 is an illustration of an optical fiber to PLC bonding method performed in accordance with an exemplary embodiment of the present invention. Free tip 110 of optical fiber 112 has freedom of movement in three linear and two angular directions (five axis) and may be aligned with a desired input/output port 114 of a planar lightwave component (PLC) 116. At step 200 (FIG. 3) a robotic pick-up arm 118 picks-up optical fiber 112. At step 202 an injector 120 injects a drop 122 of index matching and bonding material (IM&BM), which may be a glass powder paste or a sol-gel material. Injector or other material dispensing device deposits drop 122 on tip 110 of optical fiber 112. Alternatively a drop of glass powder paste or sol-gel material 124, shown in broken lines may be deposited on port 114 of PLC 116. (The side of a PLC at which the input/output ports are placed is usually termed facet.)

At step 204 alignment device (not shown) Using any known in the art passive or active alignment means aligns tip 110 of optical fiber 112 with port 114 of PLC 116. At step 206 robotic pick-up 118 arm urges optical fiber 112 towards PLC 116 until tip 110 of optical fiber 112 gets in contact with PLC 116. The actual contact with PLC 116 may not be reached. The distance between tip 110 of optical fiber 112 and PLC 116 should be such, that it enables creation of an interface 126 filled-in by the index matching and bonding material, which may be a a glass powder paste or sol-gel material 122 or 124.

At step 208 a source of curing radiation, which is a laser source is activated. The source of laser curing radiation may be a laser diode 130 or a solid state laser, such as Nd:YAG laser. Laser diode 130 is optically coupled to the other end 132 of optical fiber reel 134. Laser diode 130 delivers curing radiation to the glass powder paste or sol-gel material along (through) optical fiber reel 134 to tip 110 of optical fiber 112. At step 212 glass powder paste and sol-gel material curing radiation cures glass powder paste or sol-gel material 122 or 124 filling-in interface 126, converts it into ceramics, and bonds tip 110 of optical fiber 112 to planar lightwave component (PLC) 114. The particular glass powder paste and sol-gel material are preferably sensitized to absorb particular wavelength of laser radiation. Laser radiation may be supplied to the curing section in a continuous mode or optionally and preferably in a pulse mode.

Laser diode 130 is optically coupled to distal end 132 of optical fiber reel 134 in a way that enables curing radiation guidance along optical fiber core and cladding. This method of curing radiation guidance allows obtaining a relatively even curing radiation distribution at tip 110 of optical fiber 112. Glass powder paste or sol-gel material curing radiation irradiates simultaneously all parts of glass powder paste or sol-gel material 122 or 124 filling-in interface 126. Index matching and bonding material curing process is even; it is faster than conventional curing and does not create undesired stress.

An additional advantage of the method of curing radiation through fiber guidance is the use of a loxy power curing radiation at tip 110 for active alignment purposes. This type of alignment does not require use of additional radiation sources.

The laser curing radiation is supplied along (through) the fiber to be bonded. The cross section of multimode fibers is sufficient to enable simultaneous curing of forming interface 126 material. When use of single mode optical fiber is required optionally and preferably passive double clad single mode fibers can be used to conduct laser curing radiation to a larger portion of interface 126 than regular single mode fiber could conduct. The laser curing radiation is supplied along (through) the inner clad of the double clad fiber to be bonded.

In another exemplary embodiment glass powder paste or sol-gel material is replaced by epoxy adhesive. The particular epoxy adhesive is preferably sensitized to absorb particular wavelength of laser radiation. Laser radiation may be supplied to the curing section in a continuous mode or optionally and preferably in a pulse mode.

At step 214 robotic pick-up 118 arm slides along bonded optical fiber 112 and positions itself at a new position 138. Position 138 of robotic arm 118 is selected in a way that it leaves a desired length of optical fiber 112 between PLC 114 and position 138. A cleaving device 140 cleaves (cuts) at step 216 bonded optical fiber 112 leaving an optical fiber pigtail of desired lengths. Known in the art fiber support structures, such as V-grooves or simple flat support may be used to fix the position of bonded optical fiber 112.

At step 218 reel 134 advances and provides an additional piece of optical fiber 112. Robotic pick-Lip arm 118 that holds newly stripped and cleaved tip 110′ moves to next port 140 of PLC 114 and the process is repeated for the next port.

Cleaving device 140 is preferably a laser-cleaving device that allows both fiber striping and fiber cleaving operations to be performed by a single tool without the need of having separate fiber cleaving and fiber stripping tools. Stripping is understood to be an operation of removal of the outer polymeric layer of optical fiber. Alternatively, precut optical fiber pigtails supplied from a storage magazine (not shown) can be used in the bonding process.

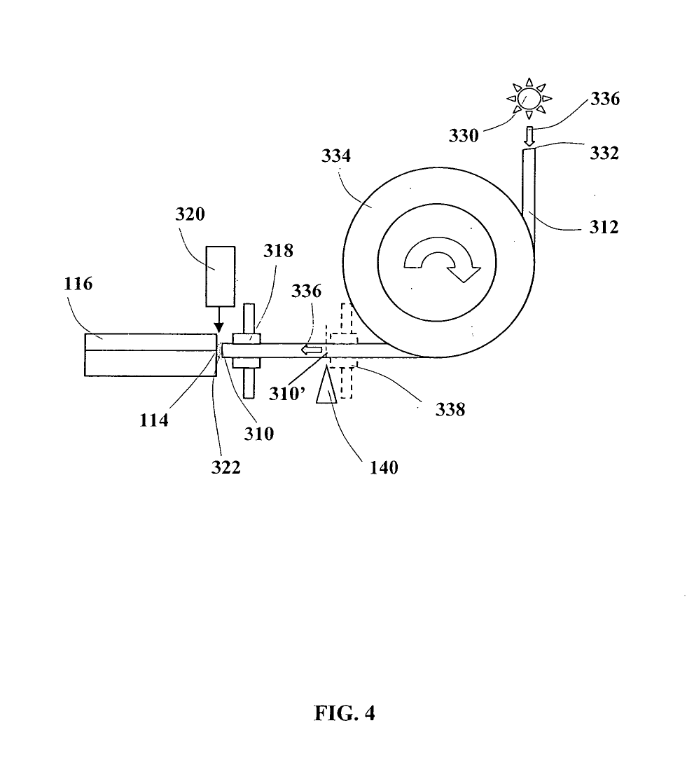

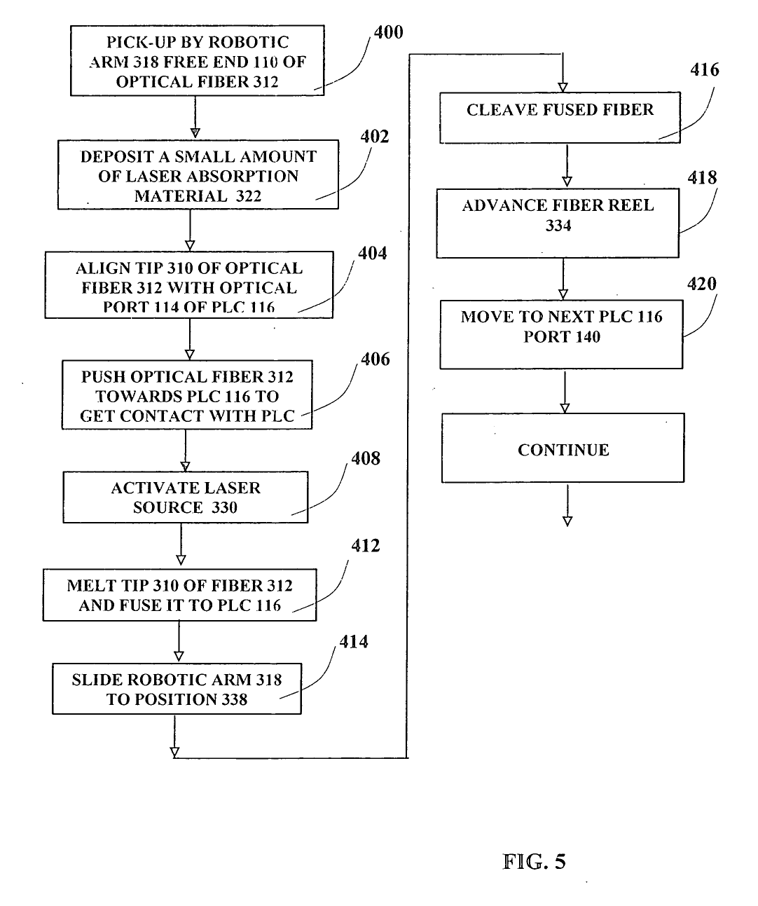

According to another exemplary embodiment of the present invention illustrated in FIG. 4 an optical fiber may be joined to at least one port of a Planar Lightwave Circuits (PLC) by laser fusion. FIG. 5 is a flowchart illustrating steps of an optical fiber to PLC laser fusion bonding method performed in accordance with present invention.

Laser fusion is a fiber joining method preferred to epoxy bonding as a melted layer of the planar component or the glass of the fiber itself produces the joint. The number of refractive index changes is reduced and accordingly a smaller amount of light power is reflected or lost. Laser radiation provides the energy required for melting the tip of the optical fiber. Optical fiber absorption of laser radiation may be not sufficient to cause fiber melting and subsequent bonding to PLC, unless proper conditions for enhanced absorption of laser radiation are created.

The method of present invention differs from known in the art laser fusion joining methods. It locally enhances laser radiation absorption of the optical fiber at the area of the desired bond. A laser absorption enhancing material such as for example laser absorbing dye SDA 2330 or similar commercially available from H.W. SANDS Corp. Jupiter, Fla. 33477 U.S.A. is used for this purpose. Laser absorbing dye SDA 2330 has peak absorption at 807 nanometers, where a large variety of high power and high brightness laser sources are available, and is fully transparent at the PLC and optical fiber operational wavelengths of 1300 nm or 1550 nm.

Laser absorbing dye may be selected to enable use of a variety of laser radiation sources such as different laser diodes, Nd:YAG lasers and others. Laser absorbing dye should preferably absorb radiation at the heating and melting laser radiation wavelength and be transparent at the PLC and fiber optics operational wavelengths. For example laser absorbing dye SDA 1168 commercially available from H.W. SANDS Corp. Jupiter, Fla. 33477 U.S.A., or yellow screen printing ink commercially available from Epolin, Inc., Newark, N.J. 07105 U.S.A., enable fusion at a wavelength of 1064 nm and is transparent at the PLC and optical fiber operational wavelengths.

At step 400 (FIG. 5) a robotic pick-up arm 318 picks-up optical fiber 312. At step 402 a small amount of laser absorption enhancing material 322 covers free tip 310 of optical fiber 312. In order to cover free tip 310 of optical fiber 312 tip 310 that has freedom of movement in three linear and two angular axis directions may be dipping into a solution containing laser absorption enhancing material or a micro-dispensing device 320 may deposit a drop of solution on it. Blotting was found to result in relatively uniform laser radiation absorption enhancing material layer.

At step 404 alignment device (not shown) aligns tip 310 of optical fiber 312 containing laser absorption enhancing material with a desired input/output port 114 of planar lightwave component (PLC) 116. The alignment process nay be active or passive. For active alignment optionally and preferably a lower level of laser heating and melting radiation may be used, and preferably radiation at the PLC operating wavelength. Robotic pick-up arm 318 urges optical fiber 312 towards PLC 116 at step 406 until tip 310 of optical fiber 312 with laser absorption enhancing material 322 gets in contact with PLC 116.

At step 408 a source of curing radiation, which is a laser source, and may be a laser diode 330 or a solid state Nd:YAG laser is activated. The energy required for melting optical fiber tip 310 with some additional 2 to 5 microns of fiber 312 length ranges from 0.002 joule to 0.3 joule. The energy required depends on the additional length of optical fiber melted and the amount of laser radiation absorption enhancing material 322. The burning of laser radiation absorption enhancing material contributes certain heat to the melting of fiber tip 310 and hence the amount of laser radiation absorption enhancing material deposited on fiber tip 110 should be constant and deposited in a repeatable way.

The additional length of optical fiber melted should be carefully controlled, since the speed with which fiber melting progresses towards the distal end of the fiber is between 0.5 m/sec to 1 m/sec (see D. D. Davis et al “A Comparative Evaluation of Fiber Fuse Models” SPIE Vol. 2966, Pages 592-606). The time required for fiber fusion is few microseconds only.

Laser radiation source, which is a solid state laser or a laser diode 330, is optically coupled to distal end 332 of optical fiber reel 334. Laser diode 330 preferably delivers to optical fiber tip 310 heating and melting radiation along (through) optical fiber reel 334. The heating and melting radiation does not affect the optical fiber since it is not absorbed by it.

Laser diode 330 or solid state laser, preferably delivers laser heating and melting radiation along optical fiber 312 to tip 310 in pulses. The repetition rate of the laser pulses is set to reduce heat spreading by heat conduction mechanism through optical fiber and PLC. Laser absorption enhancing material 322 on optical fiber tip 310 absorbs the energy delivered by laser diode 330. It heats up optical fiber tip 310. At a temperature over 1000° C. radiation absorption of glass sharply increases and the process continues faster until tip 310 begins melting. Melted glass wets the area on PLC 116, which is in contact with optical fiber tip 310 and fuses fiber tip 310, which is pushed to planar lightwave component (PLC) 116 port 114.

A variety of laser source may be used, for example laser diode 330 may be series BCS Semiconductor Laser Bar commercially available from Spectra Physics Semiconductor Lasers, Inc. Tucson, Ariz. U.S.A or SDL 2400 series Single Emitter Laser Diodes commercially available from JDS Uniphase, U.S.A., or solid state Nd:YAG laser commercially available from MSQ Ltd, Caesarea, Israel.

Solid state laser or laser diode 330, is optically coupled to distal end 332 of optical fiber reel 334 in a way that enables heating and melting radiation guidance along optical fiber core and cladding. The laser heating and melting radiation is supplied along the fiber to be joined. The cross section of multimode fibers is sufficient to conduct large energy densities required for the fusion and bonding process. When a single mode optical fiber is required optionally and preferably double clad single mode fibers can be used for the fusion and bonding process. The laser heating and melting radiation is supplied along (through) the inner clad of the double clad fiber to be bonded.

The disclosed method of heating and melting radiation guidance enables to obtain a relatively even curing radiation distribution at tip 310 of optical fiber 312, as compared with the prior art solutions that provide heating and melting radiation from one side only of the fiber and the PLC. Heating and melting radiation homogenously melts optical fiber tip 310. Melting process progresses fast, melts a minimal required length of optical fiber, and does not create undesired stress. Delivered by pulses heating and melting laser radiation is absorbed primarily by optical fiber tip, since its absorption is of an order of magnitude higher than the absorption of other participating in the process elements. Only a minimal amount of heat is conducted into PLC and it does not heat PLC creating stress in it.

At step 414 robotic pick-up arm 318 slides along bonded optical fiber 312 and positions itself at a new position 338. Position 338 is selected in a way that it leaves a desired optical fiber 312 length between PLC 114 and position 338. A cleaving device 140 cleaves at step 416 laser fused optical fiber 312 leaving a pigtail of desired lengths. Cleaving device 140 is preferably a laser-cleaving device that allows both fiber striping and fiber cleaving operations to be performed by a single tool without the need of having separate fiber cleaving and fiber stripping tools. Alternatively, precut optical fiber pigtails supplied from a storage magazine (not shown) can be used in the joining process.

At step 418 reel 334 advances and provides an additional piece of optical fiber 312. Robotic pick-up arm 318 that holds newly cleaved tip 310′ moves to next port 140 of PLC 116 and the process is repeated.

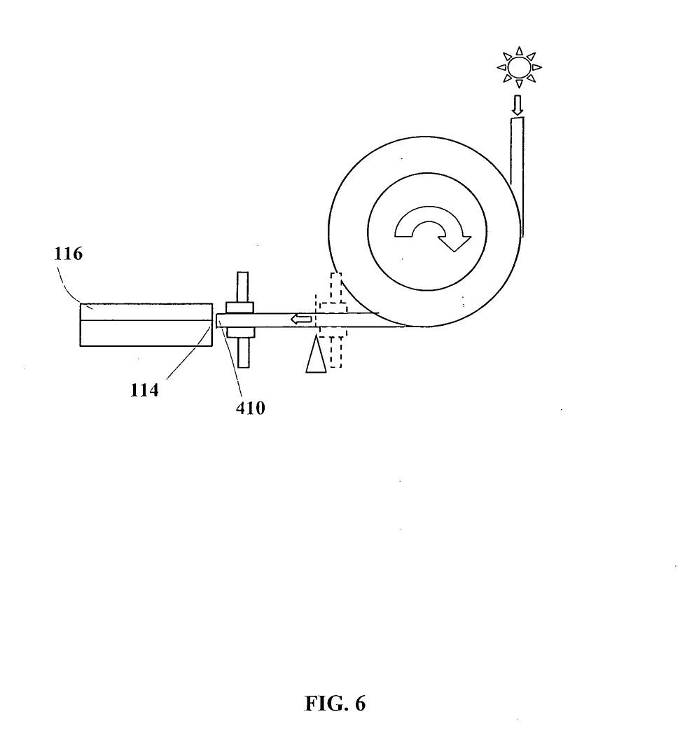

According to an additional exemplary embodiment of the present invention illustrated in FIG. 6 an optical fiber may be joined to a at least one port of a Planar Lightwave Circuits (PLC) by laser fusion without the use of laser radiation absorbing dyes or other materials causing increase in absorption at the fiber tip. In accordance with this embodiment of the present invention fiber fusion process may be ignited/initiated by reflectance from the PLC facet. PLC could be made of glass, such as Lithium Niobate or silicon. The large difference in the refractive indices of the materials, of which PLCs (116) are usually made and silica glass of which optical fiber is made cases reflection of a significant portion of the laser heating and melting radiation. The reflected laser heating and melting radiation sums-Lip with the laser heating and melting radiation emitted by laser source at fiber tip 410. The large amount of laser heating and melting radiation heats up fiber tip 410 and creates conditions where the optical fiber shows a sharp increase in absorption of laser heating and melting radiation. This temperature depending on fiber type may be in the range of temperatures of 800° C. to 1200° C. and preferably about 1050° C. When this point is reached the process continues similar to the process disclosed by the flowchart in FIG. 5.

In case where a solid state laser such as Nd:YAG with wavelength of 1.064 micron is used as a source of heating and melting radiation, melting of silicon occurs first, since silicon has melting temperature significantly lower than silica glass. Fusion of a fiber to a silicon PLC takes place in a matter of microseconds after the process is ignited.

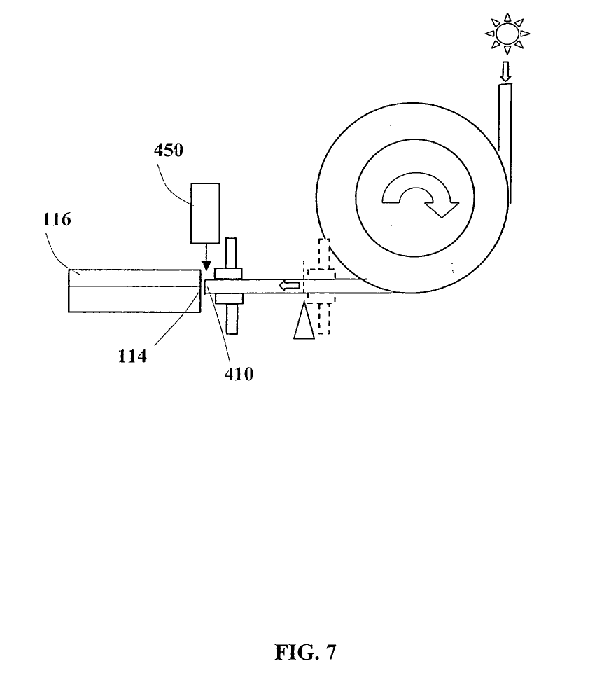

According to a further exemplary embodiment of the present invention illustrated in FIG. 7 an optical fiber may be bonded to a at least one port of a Planar Lightwave Circuits (PLC) by laser fusion without the use of laser radiation absorption dyes or other materials causing increase in absorption at the fiber tip. In accordance with this embodiment an arc or a filament 450 preheat fiber tip 410 to a temperature where the there is a sharp increase in absorption of laser heating and melting radiation. This temperature depending on fiber type and is similar to the temperature indicated above. When this point is reached the process continues similar to the process disclosed by the flowchart in FIG. 5.

This method of fiber laser fusion is advantageous over the previous methods since it does not make use of any materials in addition to the planar component or fiber itself.

While the invention has been described with respect to a limited number of embodiments, it will be appreciated that many variations, modifications and other applications of the invention may be made.

1) A method of bonding of an optical fiber to at least one port of a Planar Lightwave Circuit (PLC), comprising steps of:
a) depositing an index matching and bonding material on the tip of said optical fiber;
b) bringing in contact with said planar lightwave circuit (PLC) said tip of optical fiber having index matching and bonding material on it in a way where said index matching and bonding material serves as an interface between said port of the planar lightwave component (PLC) and said tip of optical fiber;
c) bonding said tip of optical fiber to said planar lightwave component by curing said index matching and bonding material in said interface between the planar lightwave component and optical fiber tip by curing radiation;
d) characterized in that said curing radiation loom a source of curing radiation is delivered along said optical fiber to said tip of the optical fiber to be bonded;

2) A method of bonding of an optical fiber to at least one port of a PLC as in claim 1, where said optical fiber to be bonded to at least one port of a Planar Lightwave Circuit is supplied from a reel;

3) A method of bonding of an optical fiber to at least one port of a PLC as in claim 1, where said optical fiber to be bonded to at least one port of a Planar Lightwave Circuit is supplied from a magazine of precut pigtails;

4) A method of bonding of an optical fiber to at least one port of a PLC as in claim 1, where optical fiber stripping and cleaving is performed by a laser;

5) A method of bonding of an optical fiber to at least one port of a PLC as in claim 1, where said index matching and bonding material is one of IR sensitized glass powder paste or non-organic sol-gel material;

6) A method of joining by laser fusion an optical fiber to at least one port of a Planar Lightwave Circuit (PLC), comprising steps of:
a) depositing a laser radiation absorption enhancing material on the tip of said optical fiber;
b) bringing in contact with said planar lightwave circuit (PLC) said tip of optical fiber having laser absorption enhancing material on it;
c) characterized in that said laser heating and melting energy from a source of laser heating and melting radiation is delivered along said optical fiber to said tip of the optical fiber;
d) such that said tip of optical fiber becomes fused to said planar lightwave component by said laser heating and melting radiation;

7) A method of joining of an optical fiber to at least one port of a PLC as in claim 6, where said optical fiber fusion by said laser heating and melting radiation is enhanced by said laser absorption enhancing material;

8) A method of joining of an optical fiber to at least one port of a PLC as in claim 6, where said optical fiber to be joined to at least one poll of a Planar Lightwave Circuit is supplied from a reel;

9) A method of bonding of an optical fiber to at least one port of a PLC as in claim 6, where said optical fiber to be joined to at least one port of a Planar Lightwave Circuit is supplied from a magazine of precut pigtails;

10) A method of joining of an optical fiber to at least one port of a PLC as in claim 6, where said laser heating, and melting radiation is delivered as pulses of laser radiation;

11) A method of joining of an optical fiber to at least one port of a PLC as in claim 6, where said laser absorption enhancing material is a laser radiation absorbing dye;

12) A method of joining of an optical fiber to at least one port of a PLC as in claim 6, where optical fiber stripping and cleaving is performed by a laser;

13) A method of joining by laser fusion an optical fiber to at least one port of a Planar Lightwave Circuit (PLC), comprising steps of:
a) bringing in contact (a micron gap may exist) with said port and surrounding it area (facet) of said planar lightwave component (PLC) the tip of said optical fiber;
b) characterized in that said laser heating and melting energy from a source of laser heating and melting energy is delivered along said optical fiber to said tip of the optical fiber;
c) such that said tip of optical fiber becomes fused to said planar lightwave component by said laser heating and melting energy;

14) A method of joining by laser fusion of an optical fiber to at least one port of a Planar Lightwave Circuits (PLC) as in claim 13, where said optical fiber tip fusion is performed by laser heating and melting energy being at least at the tip of the fiber a sum of conducted along the fiber and reflected from said PLC facet laser heating and melting radiation energies;

15) A method of joining by laser fusion of an optical fiber to at least one port of a Planar Lightwave Circuits (PLC) as in claim 13, where laser heating and melting radiation is delivered as pulses of laser radiation.

16) A method of joining by laser fusion of an optical fiber to at least one port of a Planar Lightwave Circuits (PLC) as in claim 13, where laser heating and melting radiation is performed through the inner clad of a double clad fiber.
